(19) United States
(12) Patent Application Publication
(10) Pub. No.: US 2023/0111935 A1
(43) Pub. Date: Apr. 13, 2023

(54) ELECTROACOUSTIC TRANSDUCER AND LOUDSPEAKER, MICROPHONE AND ELECTRONIC DEVICE COMPRISING SAID ELECTROACOUSTIC TRANSDUCER

(71) Applicant: LORENTZ AUDIO B.V., Rotterdam (NL)

(72) Inventor: Wouter DIEDEREN, Rotterdam (NL)

(73) Assignee: LORENTZ AUDIO B.V., Rotterdam (NL)

(21) Appl. No.: 17/913,278

(22) PCT Filed: Mar. 24, 2021
(86) PCT No.: PCT/NL2021/050195

§ 371 Date: Sep. 21, 2022

(30) Foreign Application Priority Data
Mar. 25, 2020 (NL) 2025207

(51) Int. Cl. H04R 9/04; H04R 7/04

(52) U.S. Cl. CPC H04R 9/047; H04R 7/04; H04R 2209/041

(57) ABSTRACT

This disclosure presents an electroacoustic transducer comprising a diaphragm with a central region and an outer region, and a dynamic coil mechanically coupled to the diaphragm, wherein the dynamic coil is arranged on or in and wound along at least a portion of the outer region of the diaphragm. At least one further coil is concentrically arranged with respect to the dynamic coil and which defines one of: an additional dynamic coil if arranged on or in and wound along at least the central region of the diaphragm, and a static field coil if wound adjacent to the diaphragm and configured to electromagnetically interact with the dynamic coil. The disclosure further relates to a loudspeaker, a microphone and an electronic device each comprising an electroacoustic transducer according to the present disclosure.

The invention relates to electroacoustic transducers.

The term electroacoustic transducer implies transduction of energy, such as carried in a signal, in two ways: from an electrical signal to an acoustic signal (a loudspeaker) and/or from an acoustic signal to an electrical signal (a microphone). The signal may be defined in either a time or frequency domain. If expressed in the frequency domain, a signal may comprise multiple frequency bands. For example, a signal may comprise a bass frequency band of lower signal frequencies, a mid-range frequency band of intermediate frequencies and a treble frequency band of higher frequencies. Generally, several electroacoustic transducers are combined to cover a frequency range that spans multiple frequency bands.

Electroacoustic transducers generally operate on the principle of electromagnetic induction and include a dynamic coil that is attached to a diaphragm. The diaphragm is excited by acoustic waves and causes the dynamic coil to vibrate within a static magnetic field produced by a permanent magnet. Conversely, an electrical signal can be applied to the dynamic coil in order to generate an alternating magnetic field which interacts with the static magnetic field to excite motion in the diaphragm and thereby produce sound waves.

The diaphragm of conventional electroacoustic transducers emits or collects sound waves over its entire surface area while the dynamic coil is attached to a small part or even single point of the diaphragm. For example, in conventional loudspeakers, the diaphragm has the shape of an end-opened cone and the dynamic coil is attached to said cone on a perimeter at its smaller opened end, and in conventional microphones, the centre of a circular diaphragm is attached to the dynamic coil.

The above electroacoustic transducers have the disadvantage of placing restrictive and mutually incompatible requirements on the diaphragm in order to transduce signals faithfully. The diaphragm of conventional electroacoustic transducers must be:
(a) infinitely stiff to propagate sound waves through the whole diaphragm;
(b) strongly sound damping to avoid ringing or otherwise affecting the received or emitted sound waves; and
(c) light in mass to reduce inertia of the diaphragm with respect to sound waves.
Since these requirements can not easily be met in known composites, let alone in known pure materials, fidelity of transduction suffers in known electroacoustic transducers and/or is restricted to relatively narrow frequency bands. For example, materials with a high stiffness also naturally have relatively weak damping characteristic.

U.S. Pat. No. 6,137,891 A discloses an electroacoustic transducer with conductor patterns forming voice coils on a sheet of pliable electrically insulating material. Multiple voice coils are shown in adjacently spaced arrangements on a diaphragm.

WO 02/063922 A2 discloses a single-ended electroacoustic transducer comprising a diaphragm with conductive strips attached for cooperation with permanent magnets arranged in parallel rows.

GB 2 071 460 A discloses an electroacoustic transducer comprising a planar type diaphragm with a voice coil arranged on the diaphragm in concentric circle segments and a magnet plate with a matching magnetisation pattern.

U.S. Pat. No. 4,471,173 A, in particular its FIGS. 6-7 and associated description, discloses a transducer having a planar diaphragm with ribs into which conductor runs are embedded. These ribs are arranged parallel to magnetised strips so that the ribs may move into and out of the spaces between the magnetized strips.

U.S. Pat. No. 6,137,891 A, WO 02/063922 A2, GB 2 071 460 A and U.S. Pat. No. 4,471,173 A are acknowledged as prior art and each describe electroacoustic transducers with a diaphragm onto which an electrical conductor is wound to serve as a dynamic coil.

It is an objective of the present invention to provide an improved electroacoustic transducer.

This is achieved by the present invention, which presents an electroacoustic transducer comprising a diaphragm with a central region and an outer region, and a dynamic coil mechanically coupled to the diaphragm, wherein the dynamic coil is arranged on or in and wound along at least a portion of the outer region of the diaphragm, and wherein at least one further coil is concentrically arranged with respect to the dynamic coil and which defines one of:
an additional dynamic coil if arranged on or in and wound along at least the central region of the diaphragm; and
a static field coil if wound adjacent to the diaphragm and configured to electromagnetically interact with the dynamic coil.

By arranging the dynamic coil on or in and wound along at least a portion of the outer region of the diaphragm, distributed mechanical contact between the dynamic coil and the diaphragm is obtained which results in better transducing and lifting restrictive material requirements. An improved and highly faithful electroacoustic transducer can now be achieved with simplified requirements for its diaphragm, which needs at most be sound damping and preferably light in mass. The previously restrictive requirement of a stiff diaphragm is no longer needed. In fact, a flexible diaphragm, which naturally also leads to better sound damping and usually is lighter, is advantageous in an electroacoustic transducers according to the invention. A flexible diaphragm faithfully follows locally exited motion by incoming or produced sound waves. The two properties of sound damping and light in mass can be combined in many different materials, such as rubbers or polycarbonates. This highly improves quality of emission and recording of sound waves.

Furthermore, a symmetrical diaphragm is not required with electroacoustic transducers according to the invention, in contrast to conventional electroacoustic transducers. The diaphragm may be planar and of essentially any two-dimensional form or may be in a three-dimensional shape, including a cube or curved surface. This further lifts restrictions on design of electroacoustic transducers. For example, the conventionally used end-opened cone shape of loudspeaker diaphragms may be dispensed with. This lifts the necessity of a central hole in such diaphragms.

According to the invention, at least one further coil is concentrically arranged with respect to the dynamic coil. This at least one further coil forms another dynamic coil if arranged on or in and wound along the diaphragm and a static field coil if wound adjacent to the diaphragm and configured to electromagnetically interact with the dynamic coil. The concentric arrangement of the dynamic coil and the at least one further coil may be in the same surface as well as spaced apart in a direction along and/or across the diaphragm. When arranged on or in and wound along the diaphragm, the at least one further coil forms another dynamic coil. When wound adjacent to the diaphragm and configured to electromagnetically interact with the dynamic coil, the at least one further coil forms a static field coil. In each case, the combination of the dynamic coil and the at least one further coil improves fidelity of the electroacoustic transducer, while providing a more versatile arrangement and a reduced thickness compared to known electroacoustic transducers. In particular, when the at least one further coil is a static field coil, the use of magnets or magnetized material producing a permanent magnetic field can be avoided.

In general, where a further coil is arranged on or in and wound along the diaphragm, it defines an additional dynamic coil. Yet, where a further coil is wound adjacent to the diaphragm and is configured to electromagnetically interact with the dynamic coil, it defines a static field coil. The concentricity of the coil arrangement is to be understood in the sense that the dynamic coil and the at least one further coil are wound about a common mathematical axis, but the coils need not be coplanar and may thus present an offset along this mathematical axis. Further, the coils need not be wound in a particular pattern, such as circle, helix or spiral. When a further coil defines an additional dynamic coil, this additional dynamic coil may be arranged at a radial offset or spacing with respect to the dynamic coil. It is also contemplated to arrange the additional dynamic coil at an offset or spacing in the thickness of the diaphragm relative to the dynamic coil instead of or in addition to the radial offset or spacing relative to the dynamic coil.

The diaphragm may serve as a frame for the dynamic coil. The dynamic coil may be wound along a complete active surface of the diaphragm to obtain mechanical contact between the dynamic coil and the diaphragm over a maximum surface area. The diaphragm may then be actuated at every location on the diaphragm irrespective of its shape.

A static magnetic field, conventionally generated by a permanent magnet, may be implemented in the electroacoustic transducer of the invention in a conventional way and alternatively in ways disclosed in the present disclosure.

Preferably, the diaphragm is substantially planar. A substantially planar diaphragm has various advantages. For example, it results in a reduced thickness of the electroacoustic transducer of the invention compared to conventional electroacoustic transducers. Furthermore, the planar shape does not require a hole in the diaphragm such as is present by necessity in conventional loudspeakers. Without such hole, the diaphragm may more faithfully emit or receive sound waves, especially at higher frequencies.

Preferably, the dynamic coil is embedded in the diaphragm. The diaphragm may thus encapsulate the dynamic coil partially or completely. When the dynamic coil is embedded in the diaphragm, mechanical contact between the dynamic coil and the diaphragm is further improved, resulting in an improved fidelity of transduction. Furthermore, this configuration results in an even thinner structure.

Preferably, the dynamic coil is electrically connected to an input or output terminal. The input or output terminal may be configured to supply the dynamic coil with an electrical signal and/or receive an electrical signal from the dynamic coil. The input or output terminal may be electrically connected to the dynamic coil by connection leads.

In an advantageous embodiment of the invention, multiple dynamic coils are arranged on or in the diaphragm, each dynamic coil being associated with a frequency band. That is, each dynamic coil may be associated with its own frequency band that is distinct or different from the acoustic frequency bands of the remaining dynamic coils. In this embodiment, each dynamic coil may be electrically connected to an input or output terminal. Multiple input or output terminals may thus be employed, each supplying or receiving signals associated with an acoustic frequency band. Additionally or alternatively, in this embodiment, the multiple dynamic coils may be concentrically arranged. Further, in this embodiment, the multiple dynamic coils may be arranged in order of acoustic frequency band. Also or alternatively, in this embodiment, the dynamic coil associated with the highest acoustic frequency band may be arranged nearest or at the central region of the diaphragm. The multiple dynamic coils may be arranged in a concentric arrangement with the dynamic coil associated with the highest acoustic frequency band in the centre. This arrangement further improves the electroacoustic transducer by receiving and emitting sound waves more accurately over a wider range of frequencies.

In any of the disclosed embodiments, the diaphragm may be elastic in the acoustic frequency band associated with the dynamic coil. The diaphragm thus damps such acoustic frequencies while also having a low inertia at said frequencies due to its elasticity. This differs from prior art diaphragms as particularly used in loudspeakers which are generally stiff rather than elastic. An elastic diaphragm is locally compliant to mechanical deformation induced through the electrical or acoustic signal. If more than one dynamic coil is provided, an equal number of associated bands may be embodied.

Preferably, the diaphragm comprises at least one material from a group comprising a rubber-like material, rubber, silicone, polyimide, polyamide, polyester resin preferably reinforced with carbon and/or glass fibres and polycarbonate. This material group ensures damping and low inertia, improving fidelity of transduction.

Advantageously, the present invention can be made transparent. This is achieved by selecting a sufficiently small wire diameter for the dynamic coil and a transparent material for the diaphragm. Due to the small thickness and the transparency of the diaphragm, the present invention creates the possibility of transparent electroacoustic transducers, which may thus be combined with display technologies.

Preferably, the diaphragm is composed of material with a Young's modulus between 0.01 GPa and 5 GPa, more preferably between 0.1 GPa and 2.4 GPa. This range is particularly suitable for exciting or receiving sound waves in the audible spectrum while having a relatively low stiffness in contrast to diaphragms of conventional electroacoustic transducers.

Preferably, an electroacoustic transducer according to the invention further comprises at least one static field coil configured to electromagnetically interact with the dynamic coil. A static field coil makes a conventional permanent magnet superfluous. This decreases mass of the transducer and spares rare-earth metals, such as neodymium, generally used in permanent magnets for electroacoustic transducers.

Preferably, the at least one static field coil is wound adjacent to the diaphragm. This strengthens the interaction between the at least one static field coil and the dynamic coil, improving the fidelity of sound transduction. Furthermore, the thickness of the electroacoustic transducer is further reduced. It is understood that any static field coil is preferably spaced from the diaphragm.

The at least one static field coil may serve as an electrical ground relative to a signal supplied to or by the dynamic coil or each of the multiple dynamic coils. Each of the at least one static field coils may be separately connected to one of the multiple dynamic coils to interact in the acoustic frequency band of said dynamic coil. In such cases, static field coils may form reference coils and may be understood to be static in a mechanical sense relative to a mechanically dynamic diaphragm.

The at least one static field coil is preferably arranged in a plane. Preferably, when the diaphragm is planar, the at least one static field coil is arranged parallel to the plane of the diaphragm. Spacing between such parallel planes is preferably smaller than a cross-section of the diaphragm. These preferred features further improve magnetic interaction and thus fidelity of sound transduction.

The static field coil may be arranged in a rigid plane, or alternatively in a second diaphragm of the same or a different stiffness compared to the diaphragm.

Preferably, the diaphragm and the at least one static field coil are arranged in a chassis configured to restrict movement of the at least one static field coil with respect to the chassis. The chassis thus restricts movement of the electromagnetic field produced by the at least one static field coil in space. The diaphragm then moves within a space-fixed electromagnetic field.

The chassis preferably comprises a 3D-printed structure. This further decreases the mass of the structure relative to prior art electroacoustic transducers, in which the chassis generally consist of two metal rings and at least three connecting legs or ribs between the two rings. Using 3D printing, much more complicated designs can be created, such as a triangular framework. A stiff chassis may thus be produced while reducing material usage. The disclosed chassis may also be employed in a conventional electroacoustic transducer such as cone-based loudspeakers.

In any of the disclosed embodiments, the diaphragm may be held by a suspension configured to suspend the diaphragm. The suspension may mount the diaphragm via a perimeter of the diaphragm, preferably the outer edge of the diaphragm.

When the electroacoustic transducer comprises both a chassis and a suspension, the chassis and the suspension may be integrated in a unitary component. This further decreases the thickness and mass of the electroacoustic transducer and simplifies its construction. It is noted that in conventional electroacoustic transducers, the chassis is of necessity stiff, while the suspension is of necessity compliant or elastic. However, with electroacoustic transducers according to the invention, the suspension may also be rigid and can thus be integrated with the chassis because the diaphragm need not be rigid nor be elastically suspended.

The invention further relates to a loudspeaker, a microphone and an electronic device each comprising an electroacoustic transducer according to the invention.

### The invention is further clarified through the following figures, wherein:

FIG. 1 schematically depicts a cross section of a conventional electroacoustic transducer for reference;

FIG. 2 schematically depicts an embodiment of an electroacoustic transducer according to the invention;

FIG. 3 schematically depicts a perspective view of an embodiment of an electroacoustic transducer with a planar diaphragm;

FIG. 4 schematically depicts a perspective view of a preferred arrangement of the diaphragm and one static field coil;

FIG. 5 schematically depicts a cross section of an electronic device comprising an electroacoustic transducer in the arrangement of FIG. 3;

FIGS. 6 to 8 schematically depict planar views of diaphragms with various arrangements of multiple dynamic coils;

FIG. 9 schematically depicts a side view of an embodiment of an electroacoustic transducer according to the invention with a chassis according to the present disclosure;

FIG. 10 schematically depicts a conventional electroacoustic transducer with a chassis according to the present disclosure;

FIG. 11 schematically depicts an arrangement of two dynamic coils, one at either side of a diaphragm; and

FIGS. 12 and 13 schematically depict embodiments of a suspension according to the present disclosure.

In the following detailed description of the figures, the example of a loudspeaker is followed to illustrate the invention in a coherent manner However, the invention should not be understood to be limited to this particular application of the electroacoustic transducer, as the limits of the present invention are solely set by the appended claims.

The following reference signs are used:

1 electroacoustic transducer,

2 diaphragm,

2.1 central region,

2.2 outer region,

3 dynamic coil,

3.1 bass coil,

3.2 mid-range coil,

3.3 treble coil,

4 input or output terminal,

5 static field magnet/coil,

6 chassis,

7 suspension,

7.1 inner angular slits,

7.2 outer angular slits,

7.3 radial slits,

8 loudspeaker,

9 microphone,

10 electronic device,

11 controller.

FIG. 1 shows a conventional electroacoustic transducer, in particular a loudspeaker, in cross section through its central axis. The illustrated conventional electroacoustic transducer has circular symmetry around said axis. The conventional loudspeaker has a diaphragm 2 in the form of an end-opened cone which is suspended by a suspension 7 that is in turn attached to a chassis 6. A dynamic coil 3 is mechanically coupled to the diaphragm 2 at the centre of the diaphragm 2 and magnetically coupled to a permanent static field magnet 5, by being arranged in an opening of the static field magnet 5. Electrical signals are supplied or received from the dynamic coil 3 by conventional means (not illustrated). An alternating electrical signal may be supplied to the dynamic coil 3 to generate alternating magnetic fields which interact with the static field from the static field magnet 5 in order to convert the electrical signal to mechanical motion of the diaphragm 2, which results in an acoustic signal in a surrounding medium. Conversely, mechanical motion of the diaphragm 2 as a result of an acoustic signal moves the dynamic coil 3 within the static field and induces an electrical signal in the dynamic coil 2.

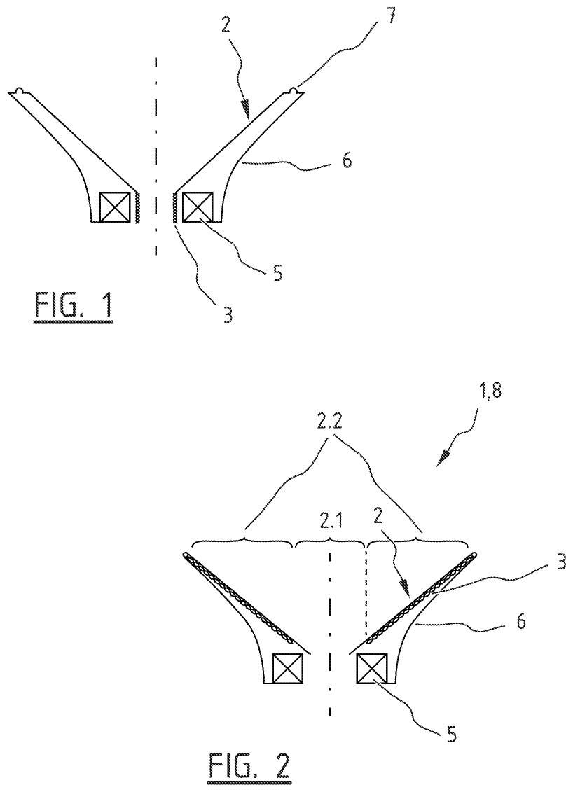

FIG. 2 shows an embodiment of an electroacoustic transducer 1 according to the invention with a diaphragm 2 having a central region 2.1 and an outer region 2.2. A dynamic coil 3 is mechanically coupled to the diaphragm 2. The dynamic coil 3 is arranged on or in at least a portion of the outer region 2.2 of the diaphragm 2. The diaphragm 2 is illustrated as an end-opened cone, such as in conventional loudspeakers, though the diaphragm 2 may have various forms or shapes, such as conical, hemispherical, spherical, planar, circular, oval, rectangular, lobed and combinations thereof, each with or without openings. Examples are presented in this disclosure.

The function of the dynamic coil 3 is moving the diaphragm 2 by creating an alternating magnetic field according to the supplied electrical signal. The mechanical coupling between the dynamic coil 3 and diaphragm 2 causes the diaphragm 2 to vibrate, thus producing sound waves. The dynamic coil 3 consists out of an electrical conductor in the form of a wire. The number of rotations of the dynamic coil 3 dependents on the density of the material of the diaphragm 2, the area of the diaphragm 2 and the density of the electrical conductor.

The electroacoustic transducer 1 of FIG. 2 further comprises a static field magnet 5, which may be a permanent magnet and/or an electromagnetic coil. In advantageous embodiments of the invention, the static field magnet 5 is a static field coil 5. The static field magnet 5 may be arranged at different positions, for example within or around the cone-shaped diaphragm which results in a thinner construction. The illustrated electroacoustic transducer 1 further comprises a chassis 6. However, the suspension 7 present in conventional electroacoustic transducers is made redundant.

The function of the static field magnet or coil 5 is to create a static magnetic field which opposes the magnetic field of the dynamic coil 3. The static field coil 5 consists out of an electrical conductor in the form of a wire. The properties of the static field coil 5 may be the same as the properties of the dynamic coil 3 but can also differ. It is further noted that the dynamic coil 3 and/or the static field coil 5 may exist out of multiple parts to limit inductance of said coils.

The electroacoustic transducer 1 of FIG. 2 is particularly suited to serve as a loudspeaker 8, though is not limited to this function. For example, it can also function as a microphone 9. The illustrated example is deliberately presented in the form of a conventional loudspeaker to show implementation of the invention within existing systems. In this example, a conventional voice coil arranged within an opening of the static field magnet 5 is replaced by the dynamic coil 2 arranged on or in at least a portion of the outer region 2.2 of a replacing diaphragm 2.

Advantages of the present invention become particularly clear when comparing the electroacoustic transducer of FIG. 1 with the electroacoustic transducer 1 of FIG. 2, both in the function of a loudspeaker with an open-ended cone shaped diaphragm 2, a dynamic coil 3, a static field magnet 5 and a chassis 6. The diaphragm 6 is actuated by movement of the dynamic coil 3. In FIG. 1, the dynamic coil 3 is arranged in a centre region of the diaphragm 2, while in FIG. 2, the dynamic coil 3 is arranged on at least a portion of an outer region of the diaphragm 2. Because of the arrangement illustrated in FIG. 2, the dynamic coil 3 actuates the diaphragm 2 over at least a portion of its outer region, in contrast to the centre region of the conventional loudspeaker of FIG. 1, in which the dynamic coil is mounted at a perimeter of the smaller open end of the diaphragm 2. The diaphragm 2 of FIG. 1 needs to be stiff, damping and low in mass to propagate sound waves through the diaphragm 2 faithfully. Moreover, a flexible suspension 7 is required. However, in FIG. 2, the diaphragm 2 need not be stiff to transfer force through the entire cone to obtain faithful sound production and no flexible suspension 7 is needed. Choice of materials is therefore increased, construction is simplified and quality of sound production is improved.

The above argument equally applies to an electroacoustic transducer 1 in the function of a microphone 9, in which sound waves are collected rather than produced. A stiff diaphragm 2 is no longer required and thus no longer limiting design of electroacoustic transducers 1.

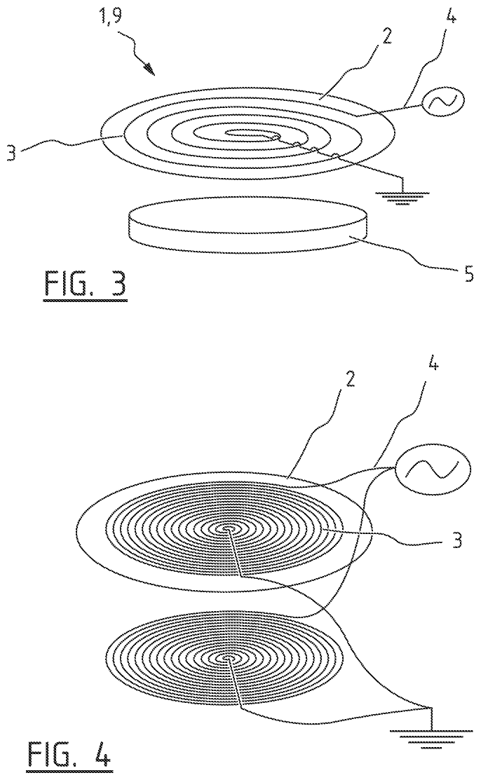

FIG. 3 shows another embodiment of an electroacoustic transducer 1 wherein the diaphragm 2 is substantially planar. The substantially planar diaphragm 2 reduces a thickness of the electroacoustic transducer 1 compared to conventional electroacoustic transducers, such as illustrated in FIG. 1. A static field magnet 5 is provided and may be a permanent magnet and/or electromagnet.

The electroacoustic transducer 1 of FIG. 3 is particularly suited to serve as a microphone 9, though is not limited to this function. For example, it can also function as a loudspeaker 8.

FIG. 4 shows a circular, planar diaphragm 2 in which a dynamic coil 3 is integrated. The dynamic coil 3 is connected to an input or output terminal 4 and to an electrical ground. A static field magnet 5 in the form of a static field coil 5 is arranged parallel to the diaphragm 2. The static field coil 5 is also connected to the input or output terminal 4 and to the electrical ground. The static field coil 5 may advantageously be wound in a plane, such as in a spiral as illustrated in FIG. 4, and/or may be fixed in space.

The embodiment of FIG. 4 constitutes an advantageously improved electroacoustic transducer 1 comprising two coils 3, 5, namely a dynamic coil 3 and a static field coil 5, that are positioned in a stacked manner with a small distance between the coils 3, 5. The dynamic coil 3 is preferably incorporated in the diaphragm 2 and thus mechanically coupled to the diaphragm 2. The dynamic coil 3 acts as a receiving coil or a voice coil while the static field coil 5 produces a static magnetic field. An electrical audio signal applied to both coils 3, 5 via input or output terminal 4 creates interacting magnetic fields which cause the two coils 3, 5 to attract or repel each other according to the applied electrical signal. The mechanical coupling between the dynamic coil 3 and the diaphragm 2 forces the diaphragm 2 to start vibrating and hence produce sound waves according to the applied electrical signal. The use of two flat coils 3, 5 results in an even thinner electroacoustic transducer which may thus be integrated in various other systems more easily.

The above features are not limited to the embodiment illustrated in FIG. 4. The electroacoustic transducer 1 of any embodiment of the invention preferably further comprises at least one static field coil 5 configured to electromagnetically interact with the dynamic coil 3. Where multiple dynamic coils 3 are employed, an equal number of static field coils 5 is preferred. The multiple static field coils 5 are then preferably arranged in a similar way as the multiple dynamic coils 3. The configuration with multiple dynamic coils 3 and/or multiple static field coils 5 is further addressed in relation to FIGS. 6-8.

The at least one static field coil 5 is preferably wound adjacent to the diaphragm 2. When the diaphragm 2 is a three-dimensional shape, the at least one static field coil 5 may be arranged parallel to the three-dimensional shape of the diaphragm 2. It is further preferred that the at least one static field coil 5 is arranged in a plane, especially when the diaphragm 2 is planar. A parallel configuration of the diaphragm 2 and the at least one static field coil 5, such as illustrated in FIG. 4, is then preferred.

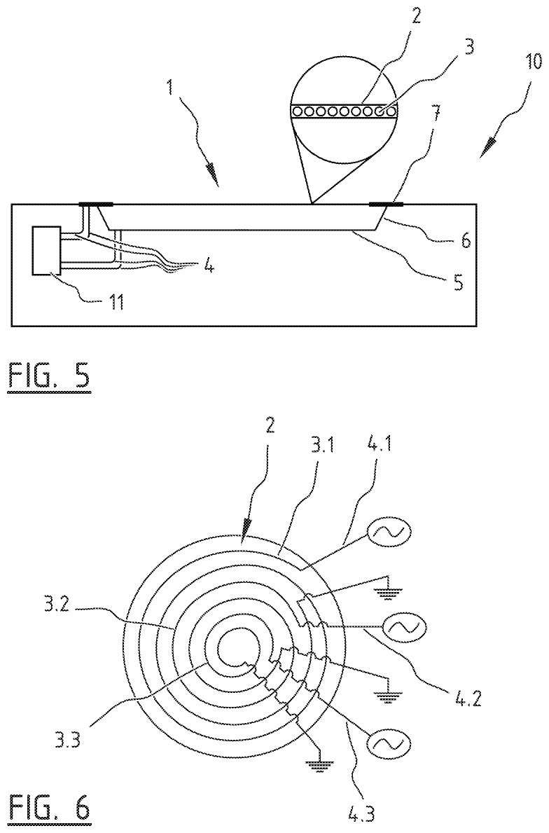

FIG. 5 shows an example of integration of the electroacoustic transducer 1 of FIG. 4 in an electronic device 10. A side view is shown in cross section. The diaphragm 2 of the electronic transducer 1 is here mounted in a suspension 7. The suspension 7 suspends the diaphragm 2, for example at a surface of the electronic device 10 in order to receive sound waves from and/or to emit sound wave to an environment that is external to the electronic device 10. A chassis 6 may be provided to fix the static field coil 5 in space. Alternatively, the chassis 6 and the suspension 7 may be integrated in a unitary component. The electronic device may further comprise a controller 11, as illustrated in FIG. 5, that is connected to the electroacoustic transducer 1 via input or output terminals 4 and is configured to provide or received electrical signals to or from the dynamic coil 3 and the static field coil 5.

The electronic device 10 has to advantage of being fully enclosed with respect to the environment because the diaphragm of the electroacoustic transducer 1 mounted in the electronic device 10 seals an opening in the electronic device 10 in which the electroacoustic transducer 1 is mounted. This contrasts with conventional electroacoustic transducers, which maintain a connection between the external and internal environments of the electronic device. Examples of these are microphones and loudspeakers in mobile devices. This has the negative consequence of soiling, malfunctioning or blocking of the electronic device and/or the electroacoustic transducers thereof. The electronic device 10 with the electroacoustic transducer 1 according to the invention is better sealed and may even be waterproof and/or gas proof.

Furthermore, electronic devices 10 may also be made smaller because less space is required for electroacoustic transducers 1 according to the invention due to their reduced thickness compared to conventional electroacoustic transducers.

Finally, the electroacoustic transducer 1 according to the invention may be used as a microphone 9 and/or a loudspeaker 8 and may additionally be switched between those functions, for example by the controller 11, so that a separate microphone 9 and a separate loudspeaker 8 are not needed and a single electroacoustic transducer 1 can be used to perform both functions.

FIGS. 6, 7 and 8 show planar views of diaphragms 2 with multiple dynamic coils 5. The multiple dynamic coils 5 are arranged on or in the diaphragm 2. Each dynamic coil 5 is preferably associated with an acoustic frequency band. This can be achieved, for example, by supplying or receiving electrical signals to each dynamic coil 5 separately. Each of the multiple dynamic coils 5 may be electrically connected to an input or output terminal 4 Jointly, the multiple dynamic coils 5 may thus cover a selected acoustic frequency spectrum faithfully.

With multiple dynamic coils 5 on or in a single diaphragm 2, the electroacoustic transducers 1 according to the invention may cover a wider frequency range. Furthermore, combinations of multiple electroacoustic transducers, as is conventionally the case, may be avoided and a single electroacoustic transducer 1 according to the invention may be employed to cover similar frequency bands with one device.

In FIG. 6, a circular diaphragm 6 is illustrated with three dynamic coils 3, labelled 3.1, 3.2 and 3.3. The coils 3.1, 3.2, 3.3 are concentrically arranged and each is electrically connected to a separate input or output terminal 4, labelled 4.1, 4.2 and 4.3 corresponding to their respective coils 3.1, 3.2, 3.3. In the illustrated example, the dynamic coil 3.1 may be a bass coil 3.1, the dynamic coil 3.2 may be a mid-range coil 3.2 and the dynamic coil 3.3 may be a treble coil 3.3 so that the bass coil 3.1, the mid-range coil 3.2 and the treble coil 3.3 are arranged in order of acoustic frequency band with the treble coil 3.3 with the highest acoustic frequency band arranged nearest or at the central region of the diaphragm 2. As illustrated, the dynamic coils 3 are arranged over the diaphragm 2 at a radial offset or spacing with respect to each other.

As a loudspeaker, each input terminal 4 1, 4.2, 4.3 receives its own audio supply from which higher frequency signals are filtered out according to the frequency band of each of the multiple dynamic coils 3.1, 3.2, 3.3. For the bass coil 3.3, the input terminal 4 3 supplies lower acoustic frequencies than the input terminal 4.2 to the mid-range coil 3.2. In turn, the input terminal 4.2 supplies lower acoustic frequencies to the mid-range coil 3.2 than the input terminal 4.1 to the treble coil 3.1. Thus, the larger a dynamic coil 3.1, 3.2, 3.3, the lower the frequency band supplied to it. Though this arrangement is preferred, other orders and two or four or more dynamic coils 3 may be considered.

Splitting the dynamic coil 3 into multiple parts has the advantage that the centre of the diaphragm 2 vibrates with frequencies in the entire sound spectrum while the outer part of the diaphragm 2 vibrates with lower parts of the sound spectrum. The frequencies which are produced by the different areas are limited by acoustic wavelength and size of the diaphragm 2, in this example the diameter of the circular diaphragm 2. When the wavelength is smaller than said diameter, waves start to travel through the surface of the diaphragm 2. This causes faults in the sound produced. The number of areas and corresponding diameters can be determined based on the wavelengths of different octaves. This produces a full-range loudspeaker 8 with faithful sound production.

Though the above advantages are explained with FIG. 6 interpreted as a loudspeaker 8, similar advantages are obtained with a microphone 9 in which the dynamic coil 5 is split into multiple dynamic coils 5, each associated with an acoustic frequency band.

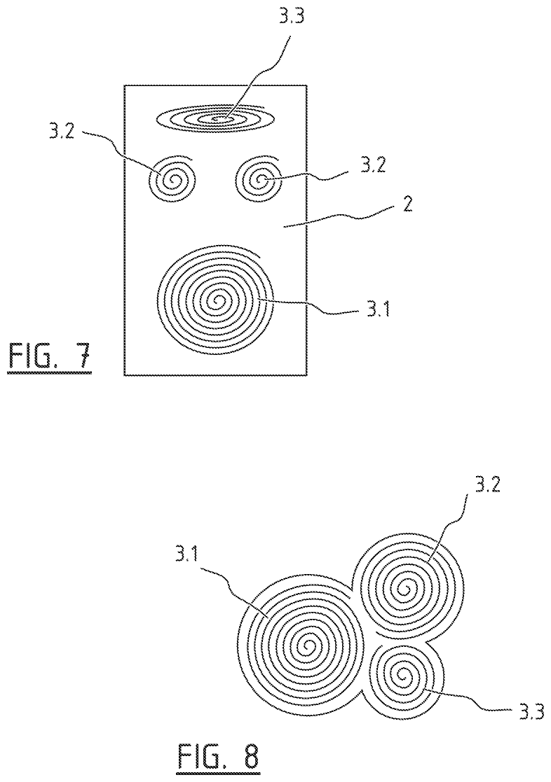

FIG. 7 shows an alternative arrangement of multiple dynamic coils 5 in a rectangular diaphragm 2. Here, a single bass coil 3.1, two mid-range coils 3.2 and a single treble coil 3.3 are illustrated. Multiple dynamic coils 5 may be arranged to cover the same or a similar frequency band in any embodiment of the invention. The input or output terminals 4 have been omitted from the illustration for clarity.

FIG. 8 shows an alternative arrangement of multiple dynamic coils 3 in a lobed diaphragm 2. A bass coil 3.1 is arranged on or in the largest lobe of the diaphragm 2, a mid-range coil 3.2 is arranged in an intermediate lobe of the diaphragm 2 and a treble coil 3.3 is arranged in the smallest lobe of the diaphragm 2. Preferably, the diaphragm 2 is fixed around its outer perimeter within a suspension 7 and/or chassis 6. The input or output terminals 4 have been omitted from the illustration for clarity.

In the above, FIGS. 6, 7 and 8 are discussed as diaphragms 2 with dynamic coils 3. However, these figures also relate to arrangements of multiple static field coils 5 that may be combined with corresponding diaphragms 2 and multiple dynamic coils 3 to arrive at advantageous electroacoustic transducers 1 in line with, for example, FIGS. 4 and 5. For example, the lobed diaphragm of FIG. 8 with three dynamic coils 3 may be combined with three static field coils 5 in the same arrangement as the three dynamic coils 3, wherein each static field coil 5 is configured to magnetically interact with a corresponding one of the dynamic coils 3.

FIG. 9 shows an electroacoustic transducer 1 according to an embodiment of the invention with a chassis 6 in a side view. The chassis 6 is configured to restrict movement of the at least one static field coil 5 with respect to the chassis 6. The chassis 6 may further hold the diaphragm 5, optionally via a suspension 7 configured to suspend the diaphragm 2. In FIG. 9, the suspension 7 is illustrated separately for clarity, though may also be incorporated in the chassis 6, preferably as a unitary component. For example, the suspension 7 and chassis 6 may be milled from a solid piece of metal or may be fabricated jointly by 3D-printing.

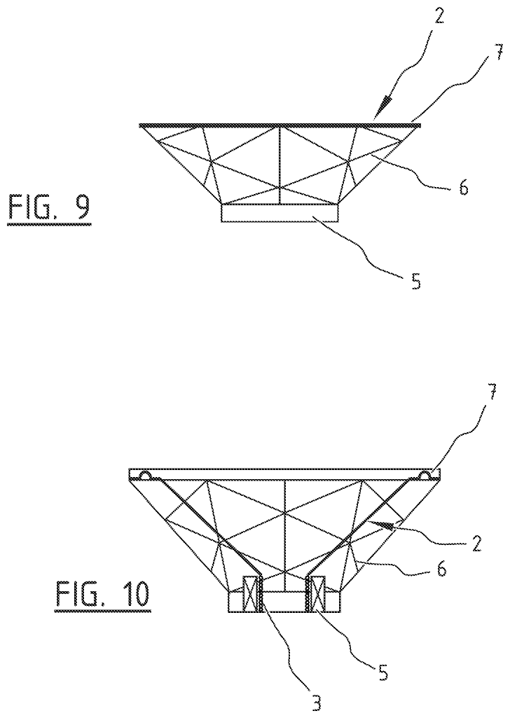

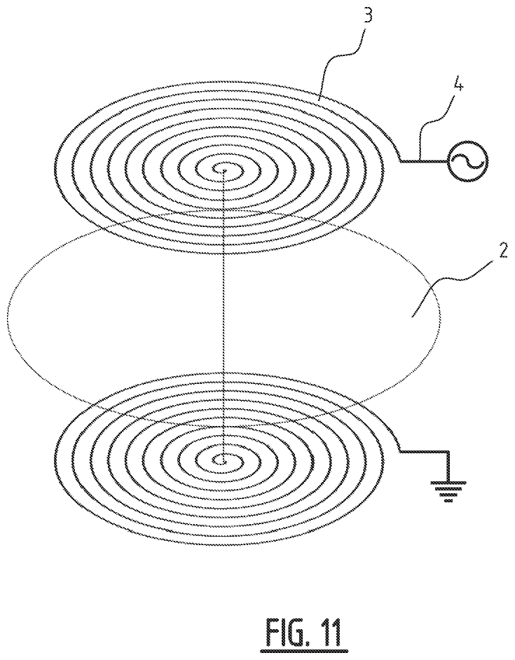

In a preferred embodiment of the chassis 6, the chassis 6 comprises a 3D-printed structure. Alternatively or additionally, the chassis 6 comprises triangular structures. These provide strength to the chassis 6 and fix the at least one static field coil 5 with respect to the chassis 6, thus allowing the at least one static field coil 5 to provide the static field in which the diaphragm 2 can vibrate freely to obtain faithful electroacoustic transduction. As illustrated in FIGS. 9 and 10, the 3D-printed structure defines ribs of the chassis 6 supporting the diaphragm 2 relative to the at least one static field coil 5.

FIG. 10 shows a conventional electroacoustic transducer with a chassis 6 according to the present disclosure. The chassis 6, shown in side view, here mounts the conventional loudspeaker of FIG. 1, components of which are shown in cross section to indicate their position within the chassis 6. The chassis 6 keeps the static field due to the permanent static field magnet 5 at a position fixed in space. It is thus understood that the chassis 6 may be employed with electroacoustic transducers 1 according to the present invention as well as with conventional electroacoustic transducers.

As the chassis 6 according to the present disclosure may be 3D-printed, preferably with triangular structures, the chassis 6 is of a relatively simple and stiff design. Even more complicated designs are possible. This creates the possibility to produce a stiffer chassis using less material compared to prior art chassis. In prior art, the chassis generally consist out of two metal rings stacked on top of each other with a certain distance between them. These rings are connected by three metal beams with a spacing of 120 degrees between each beam.

FIG. 11 shows an advantageous arrangement of two dynamic coils 3 on or in the diaphragm 2. As illustrated here, a first dynamic coil 3 is arranged on or in an upper side of the diaphragm 2 and a second dynamic coil 3 is arranged on or in a lower side of the diaphragm 2 opposite the upper side. (The two dynamic coils 3 are illustrated at an exaggerated mutual spacing for clarity.) Arranging the dynamic coils 3 in such a way increases contact between the dynamic coil 3 and the diaphragm 2 to improve fidelity and longevity of the electroacoustic transducer 1. The two dynamic coils 3 are mutually connected through or across the diaphragm 2, for example by electrical contact arranged through or perforating the diaphragm 2. The input or output terminal 4 and electrical ground may now be arranged at an outer perimeter of the diaphragm 2 without overlap with windings of the dynamic coils 3 (which is the case in FIGS. 3 and 6). This reduces distortion in the magnetic field and thus further enhances fidelity of the transducer 1. Moreover, the two dynamic coils 3 may be wound in the same direction (e.g. clockwise or anticlockwise) when viewing from one side of the diaphragm 2. In such arrangement, each the dynamic coil 3 strengthens a magnetic field (or is sensitive to an external magnetic field) of the other in a similar way. Alternatively or additionally, the two dynamic coils 3 may be arranged in parallel planes and/or be configured to follow a spatially off-set yet identical path. This further improves sensitivity of the electroacoustic transducer 1 by the joint electromagnetic interaction of the two dynamic coils 3.

As shown in FIG. 11, the first and second dynamic coils 3 are arranged at an offset along the thickness of the diaphragm relative to each other. This offset may be employed instead of or in addition to a radial offset between the two dynamic coils 3. The two dynamic coils 3 are electrically connected through or across the diaphragm 2 and may be configured to receive the same electroacoustic signal from a joint input or output terminal 4 arranged at an outer perimeter of the diaphragm 2. In this arrangement, leads running over the diaphragm or stationary terminals in potentially active areas of the diaphragm are avoided, thus further improving fidelity and power transmission of the electroacoustic transducer.

Though two dynamic coils 3 are illustrated in FIG. 11, this arrangement may be applied to multiple pairs of dynamic coils 3, for example as illustrated in FIGS. 6, 7 and 8. Contacts of each pair of dynamic coils 3 that perforate the diaphragm 2 may also be arranged radially offset rather than centrally. The dynamic coils 3 and/or lead for their input or output terminal(s) 4 or electrical ground(s) may be embedded in the diaphragm 2 at various depth positions.

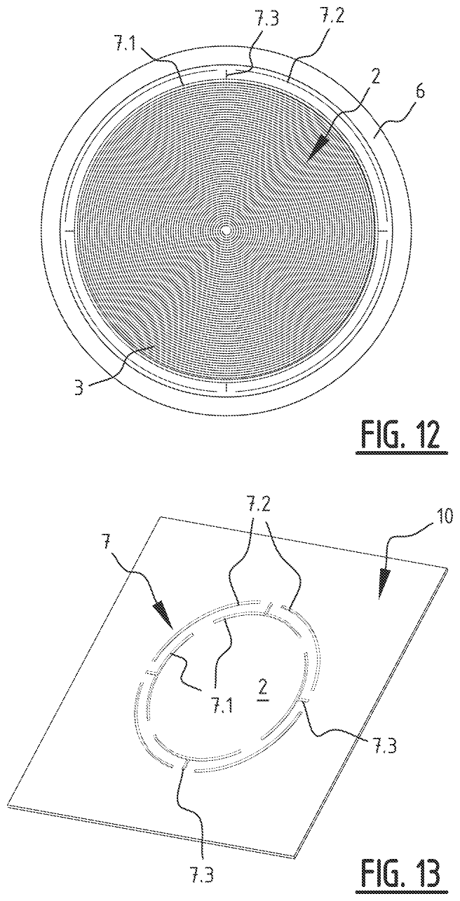

FIGS. 12 and 13 show an advantageous suspension 7 for a diaphragm 2. The suspension is configured to improve acoustic insulation of the diaphragm 2 from attached structures. As illustrated in FIG. 12, the structure of the suspension 7 may be provided by arranging slits in the diaphragm 2. The suspension 7 may thus be integral with the diaphragm 2. Alternatively, the suspension 7 of the illustrated embodiment may be provided as a distinct component. The slits are configured to reduce transfer of mechanical vibrations across the suspension 7 by defining a tortuous path of mechanical connectivity between components internally and externally coupled to the suspension 7 (e.g. the diaphragm 2 and the chassis 6).

As illustrated in FIGS. 12 and 13, the suspension 7 comprises inner angular slits 7.1, outer angular slits 7.2 and radial slits 7.3. Here, the terms angular and radial indicate directions relative to the centre of a plane or space enclosed by the suspension 7 (e.g. the diaphragm 2). The inner and outer angular slits 7.1, 7.2 partly overlap in angular direction but are spaced apart in radial direction. The radial slits 7.3 are connected to the inner angular slits 7.1 and preferably protrude towards a radial dimension corresponding to the outer angular slits 7.3 and may protrude to a position between two outer angular slits 7.3. Though the angular slits 7.1, 7.2 are illustrated as concentric circle segments, other shapes are possible such as elliptical, linear and angled forms. The radial slits 7.3 may also be implemented with angular components. Various alternative arrangements of the slits 7.1, 7.2, 7.3 are thus conceivable.

The suspension 7 of FIGS. 12 and 13 thus provides mechanical integrity yet improves acoustic insulation of the plane or space enclosed by the suspension 7 (e.g. the diaphragm 2) and adjacent structures (e.g. the chassis 6 or the electronic device 10). The slits 7.1, 7.2, 7.3 may thus define the suspension 7, while the diaphragm 2 may in turn be delineated by the suspension 7. For example, the suspension 7 may be provided in a flat object, such as a face of an electronic device 10, and define the diaphragm 2 as the part enclosed by the suspension 7, e.g. as shown in FIG. 13. The slit structure defining the suspension 7 may thus be employed with known electroacoustic transducers as well as with the electroacoustic transducer 1 according to the invention.

The diaphragm 2 of any embodiment of the invention is preferably elastic in the acoustic frequency bands associated with the multiple dynamic coils 3.1, 3.2, 3.3 or at least the frequency band of the dynamic coil 3 where only one dynamic coil 3 is present. Additionally or alternatively, the diaphragm 2 comprises at least one material from a group, the group comprising a rubber-like material, rubber, silicone, polyimide, polyamide, polyester resin and polycarbonate, preferably reinforced with carbon and/or glass fibres. The materials from this group possess sufficient flexibility to conform to local deformation due to impinging sound waves and/or to actuation by the one or multiple dynamic coil(s) 3. Additionally or alternatively, the diaphragm 2 is composed of a non-stiff material, preferably with a Young's modulus between 0.1 GPa and 2.4 GPa. In tests of an electroacoustic transducer according to an embodiment of the invention, these materials and this range was found to provide effective transduction of electrical signals to acoustic signals.

A loudspeaker 8 may comprise an electroacoustic transducer 1 according to the invention. Examples are illustrated in the figures, particularly in FIG. 2. When a loudspeaker 8 comprises an electroacoustic transducer 1 according to the invention, the dynamic coil 3 is configured as a voice coil which receives an electrical signal and is configured to transduce the electrical signal into an acoustic signal upon electromagnetic interaction with a static field magnet 5. The static field magnet 5 can be a permanent magnet or an electromagnet, such as the static field coil 5 of preferred embodiments of the disclosed electroacoustic transducer 1.

A microphone 9 may comprise an electroacoustic transducer 1 according to the invention. Examples are illustrated in the figures, particularly in FIG. 3. When a microphone 9 comprises an electroacoustic transducer 1 according to the invention, the dynamic coil 3 is configured to receive an acoustic signal and transduce the acoustic signal into an electrical signal upon electromagnetic interaction with a static field magnet 5. The static field magnet 5 can be a permanent magnet or an electromagnet, such as the static field coil 5 of preferred embodiments of the disclosed electroacoustic transducer.

An electronic device 10 may comprise an electroacoustic transducer 1 according to the invention. Examples are illustrated in the figures, particularly in FIG. 5. When an electronic device 10 comprises an electroacoustic transducer 1 according to the invention, the electroacoustic transducer 1 can be configured to act as a loudspeaker 8 and/or microphone 9 in distinct or similar frequency bands. In preferred embodiments, the diaphragm 2 is planar and holes are absent, thus providing an electroacoustic transducer 1 which may advantageously seal an opening in the electronic device 10 arranged to receive the electroacoustic transducer 1.

Though various features of the invention have been described with and illustrated in separate figures, it is understood that these features can be combined to obtain advantageous embodiments of the invention. For example, in any of the embodiments of the invention, a chassis may be provided with a static field magnet 5 and/or the static field magnet 5 may be at least one static field coil 5. Further, the dynamic coil 3 or the multiple dynamic coils 3, 3.1, 3.2, 3.3 may each be electrically connectable or connected to an input or output terminal 4, 4.1, 4.2, 4.3. The present disclosure is not limited to the illustrated configurations and the scope of protection is only limited by the appended claims.

1-22. (canceled)

23. An electroacoustic transducer comprising:
a diaphragm with a central region and an outer region;
a dynamic coil mechanically coupled to the diaphragm and arranged on or in at least a portion of the outer region of the diaphragm; and
an additional dynamic coil concentrically arranged with respect to the dynamic coil about a common mathematical axis and arranged on or in at least the central region of the diaphragm,
wherein the dynamic coil and the additional dynamic coil are each wound along the diaphragm, and
wherein the dynamic coil and/or the additional dynamic coil are embedded in the diaphragm.

24. The electroacoustic transducer of claim 23, wherein the diaphragm is substantially planar.

25. The electroacoustic transducer of claim 23, wherein the dynamic coil is electrically connected to an input or output terminal.

26. The electroacoustic transducer of claim 25, wherein the additional dynamic coil is electrically connected to the same input or output terminal.

27. The electroacoustic transducer of claim 26, wherein the additional dynamic coil is electrically connected to the same input or output terminal via the dynamic coil.

28. The electroacoustic transducer of claim 26, wherein the dynamic coil and the additional dynamic coil are electrically connected to each other through the diaphragm and configured to receive the same electroacoustic signal from a joint input or output terminal arranged at an outer perimeter of the diaphragm.

29. The electroacoustic transducer of claim 23, wherein the dynamic coil and the additional dynamic coil are electrically connected to separate input or output terminals.

30. The electroacoustic transducer of claim 29, wherein the dynamic coil and the additional dynamic coil are each associated with their own acoustic frequency band.

31. The electroacoustic transducer of claim 29, wherein the additional dynamic coil is associated with a higher acoustic frequency band than the dynamic coil.

32. The electroacoustic transducer of claim 23, wherein the dynamic coil and the additional dynamic coil are concentrically arranged on or in and wound along the diaphragm with a mutual spacing.

33. The electroacoustic transducer of claim 23, wherein the additional dynamic coil is spaced from the dynamic coil at a radial offset along the diaphragm.

34. The electroacoustic transducer of claim 23, wherein the additional dynamic coil is spaced from the dynamic coil at an axial offset along the common mathematical axis.

35. The electroacoustic transducer of claim 23, wherein the diaphragm is elastic in acoustic frequency bands associated with the dynamic coil and the additional dynamic coil.

36. The electroacoustic transducer of claim 23, further comprising a static field coil wound adjacent to the diaphragm and configured to electromagnetically interact with the dynamic coil.

37. The electroacoustic transducer of claim 36, wherein the static field coil is electrically connected to the same input or output terminal as the dynamic coil.

38. The electroacoustic transducer of claim 36, wherein the static field coil is arranged in a plane.

39. A diaphragm for an electroacoustic transducer, wherein the diaphragm comprises:
a dynamic coil mechanically coupled to the diaphragm and arranged on or in at least a portion of the diaphragm; and
an additional dynamic coil concentrically arranged with respect to the dynamic coil about a common mathematical axis and arranged on or in the diaphragm,
wherein the dynamic coil and the additional dynamic coil are each wound along the diaphragm, and
wherein the dynamic coil and/or the additional dynamic coil are embedded in the diaphragm.

40. The diaphragm of claim 39, wherein:
the diaphragm has a central region and an outer region;
the dynamic coil is arranged on or in at least a portion of the outer region of the diaphragm; and
the additional dynamic coil is arranged on or in at least the central region of the diaphragm.

41. An electroacoustic transducer comprising:
a diaphragm;
a dynamic coil mechanically coupled to the diaphragm, wherein the dynamic coil is arranged on or in and wound along at least a portion of the diaphragm; and
a static field coil concentrically arranged with respect to the dynamic coil, wound adjacent to the diaphragm and configured to electromagnetically interact with the dynamic coil.

42. The electroacoustic transducer of claim 41, wherein at least one of:
the dynamic coil is embedded in the diaphragm;
the static field coil is electrically connected to the same input or output terminal as the dynamic coil;
the diaphragm is planar;
the static field coil is arranged in a plane; and
the diaphragm and the static field coil are arranged in a chassis configured to restrict movement of the static field coil with respect to the chassis.
